(19) United States
(12) Patent Application Publication
(10) Pub. No.: US 2024/0168560 A1
(43) Pub. Date: May 23, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: AYUMI NAKAGAWA, TOKYO (JP); KEIICHIRO TANIGUCHI, TOKYO (JP)

(21) Appl. No.: 18/550,988

(22) PCT Filed: Feb. 10, 2022
(86) PCT No.: PCT/JP2022/005341

§ 371 Date: Sep. 18, 2023

(30) Foreign Application Priority Data
Mar. 26, 2021 (JP) 2021-054337

(51) Int. Cl. G06F 3/01

(52) U.S. Cl. CPC G06F 3/016

(57) ABSTRACT

Disclosed is an information processing apparatus including an input information acquisition section that acquires input information inputted by a user operation performed on an adjustment object, and a tactile sensation presentation control section that exercises control to cause a tactile sensation presentation device to provide tactile sensation presentation according to usage of the adjustment object that is based on the input information.

### TECHNICAL FIELD

The present technology relates to an information processing apparatus, an information processing method, and a program, and more particularly relates to a tactile sensation presentation technology.

### BACKGROUND ART

Developed in recent years is a technology for providing tactile stimulation to a user by causing a user-operated apparatus to vibrate. Here, tactile stimulation denotes a physical phenomenon that uses, for example, a vibration to make the user feel tactile sensation. Further, generating tactile stimulation is referred to as tactile sensation presentation.

The tactile sensation presentation technology is used in equipment in various fields.

For example, a terminal apparatus having a touch panel, such as a smartphone, is able to vibrate the touch panel or a housing of the terminal apparatus in response to a user's touch operation and thus provide tactile stimulation to a user's finger, thereby expressing the sense of touch, for example, on a button displayed on the touch panel.

Further, for example, a music-listening apparatus, such as headphones, is able to provide tactile stimulation according to music reproduction, thereby accentuating deep bass in the music being reproduced.

Moreover, for example, an apparatus for providing a computer game or VR (Virtual Reality) is able to reproduce sound and vibrate, for instance, a controller according to a controller operation or a scene of content and thus provide tactile stimulation, thereby increasing a user's sense of immersion in the content.

As such an apparatus that provides tactile sensation presentation to the user, there is proposed an apparatus that provides tactile sensation presentation varying with the type of input information successively acquired while a position touched by a user's touch operation changes.

### CITATION LIST

### Patent Literature

### PTL 1

PCT Patent Publication No. WO2018/043136

### SUMMARY

### Technical Problem

However, the apparatus that provides tactile sensation presentation as described above is configured to provide tactile sensation presentation matching predefined conditions. Therefore, there arises a problem that the tactile sensation presentation becomes stereotypical. Consequently, it is demanded that the apparatus that provides tactile sensation presentation has improved usability (usage sensation).

In view of the above circumstances, an object of the present technology is to improve usability.

### Solution to Problem

An information processing apparatus according to the present technology includes an input information acquisition section that acquires input information inputted by a user operation performed on an adjustment object, and a tactile sensation presentation control section that exercises control to cause a tactile sensation presentation device to provide tactile sensation presentation according to usage of the adjustment object that is based on the input information.

Consequently, the information processing apparatus is able to cause the tactile sensation presentation device to provide tactile sensation presentation that varies with adjustment object usage based on the input information.

### BRIEF DESCRIPTION OF DRAWING

FIG. 1 is a diagram illustrating an appearance of an imaging apparatus.

FIG. 2 is a diagram illustrating the appearance of the imaging apparatus.

FIG. 3 is a diagram illustrating an internal configuration of the imaging apparatus.

FIG. 4 is a set of diagrams illustrating a screen (GUI) that is displayed when an Ev value is to be changed.

FIG. 5 is a flowchart illustrating a flow of a tactile sensation presentation control process.

FIG. 6 is a set of diagrams illustrating a vibration waveform in a first embodiment.

FIG. 7 is a set of diagrams illustrating the vibration waveform in a second embodiment.

FIG. 8 is a flowchart illustrating a flow of processing in the second embodiment.

FIG. 9 is a set of diagrams illustrating the vibration waveform in a third embodiment.

FIG. 10 is a flowchart illustrating a flow of a database construction process in a fourth embodiment.

FIG. 11 is a diagram illustrating the vibration waveform in a sixth embodiment.

FIG. 12 is a flowchart illustrating a flow of the database construction process in the sixth embodiment.

FIG. 13 is a diagram illustrating the vibration waveform in a seventh embodiment.

FIG. 14 is a flowchart illustrating a flow of the database construction process in the seventh embodiment.

### DESCRIPTION OF EMBODIMENTS

Embodiments will now be described in the following order.
<1. Configuration of Imaging Apparatus>
<2. Change of Parameters>
<3. Overview of Tactile Sensation Presentation Process>
<4. Embodiments>
<5. Modifications>
<6. Conclusions>
<7. Present Technology>

### 1. Configuration of Imaging Apparatus

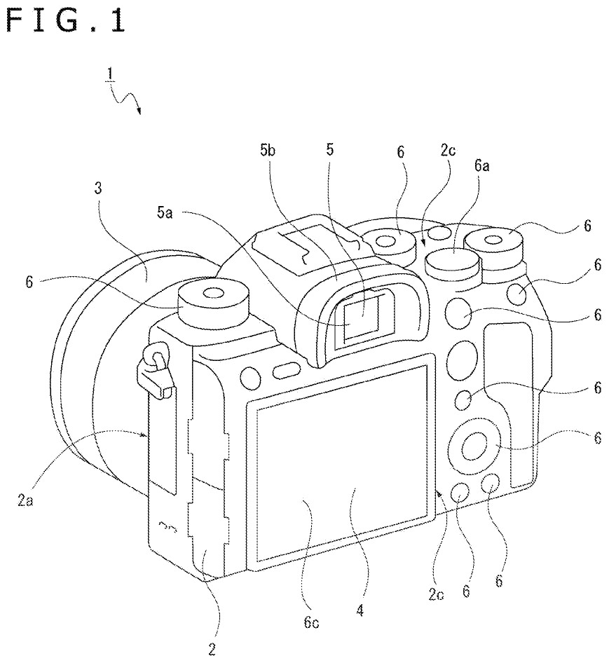

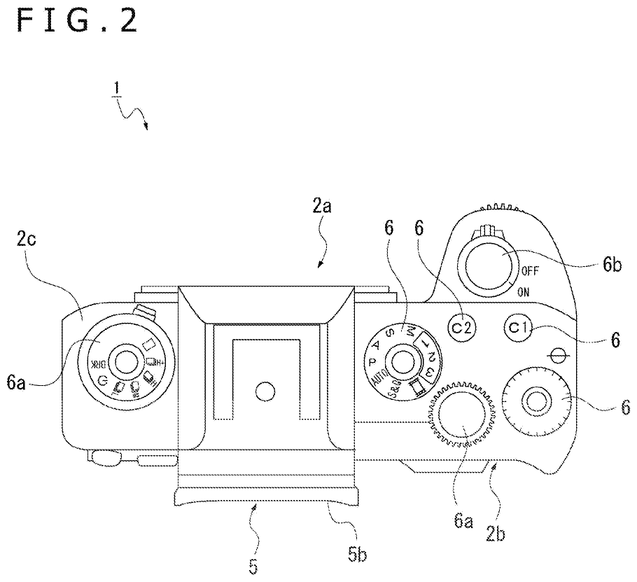

FIGS. 1 and 2 illustrate an appearance of an imaging apparatus 1 that is configured as an information processing apparatus according to an embodiment.

Incidentally, the following description assumes that a subject is in a forward position while a camera operator is in a rearward position.

As depicted in FIGS. 1 and 2, the imaging apparatus 1 includes a camera housing 2 and a lens barrel 3. Required parts are disposed inside and outside the camera housing 2. The lens barrel 3 is detachably mounted on a front surface part 2a of the camera housing 2. FIG. 2 depicts the camera housing 2 with the lens barrel removed.

It should be noted that, as merely an example, the lens barrel 3 may be detachable as what is generally called an interchangeable lens. The lens barrel 3 may alternatively be non-removable from the camera housing 2.

A rear monitor 4 is disposed on a rear surface part 2b of the camera housing 2. The rear monitor 4 displays, for example, reproduction of a live view image or a recorded image.

The rear monitor 4 includes, for example, a display device such as a liquid-crystal display (LCD) or an organic EL (Electro-Luminescence) display.

The rear monitor 4 is pivotable relative to the camera housing 2. For example, the rear monitor 4 is pivotable in such a manner that an upper end of the rear monitor 4 acts as a pivot axis to allow a lower end of the rear monitor 4 to move rearward. It should be noted that a right end or a left end of the rear monitor 4 may alternatively act as the pixel axis. Further, the rear monitor 4 may alternatively be pivotable around multiple axes .

An EVF (Electric Viewfinder) 5 is disposed on an upper surface part 2c of the camera housing 2. The EVF 5 includes an EVF monitor 5a and a frame-shaped enclosure 5b. The frame-shaped enclosure 5b protrudes rearward to surround upper, left, and right sides of the EVF monitor 5a.

The EVF monitor 5a includes, for example, an LCD or an organic EL display. It should be noted that an optical viewfinder (OVF) may be disposed in place of the EVF monitor 5a.

Various operating elements 6 are disposed on the rear surface part 2b and the upper surface part 2c. The operating elements 6 are, for example, a shutter button (release button), a reproduction menu activation button, an enter button, a cross key, a cancel button, a zoom key, and a slide key.

For example, various types of buttons, dials, and depressible or rotatable complex operating elements may be used as the operating elements 6. The various types of operating elements 6 make it possible to perform, for example, a shutter operation, a menu operation, a reproduction operation, a mode selection operation, a focus operation, a zoom operation, and a parameter change operation. It should be noted that, for example, a shutter speed, an EV value, and an F value may be used as parameters.

A dial 6a for changing the parameters is disposed as one of the operating elements 6. The dial 6a is a rotary operating element. For example, in response to a user's rotation operation, the dial 6a outputs a signal (input information) each time a ball fits into a groove formed at predetermined angles. That is, the dial 6a outputs a signal once each time the dial 6a is rotated by the predetermined angle. It should be noted that an operation performed by the dial 6a to output a signal once is referred to as one notch.

Further, since the ball fits into a groove at one-notch intervals, the dial 6a provides tactile stimulation (dial vibration) to a user at one-notch intervals. Consequently, the user is able to estimate, from the tactile stimulation, the degree of change applied to a parameter (how many stages of change are applied to the parameter).

Further, when rotated by the user, the dial 6a is able to output a signal multiple times in a row. That is, by continuously rotating the dial 6a, the user is able to successively change the parameter in multiple stage.

It should be noted that the dial 6a may have a different structure such as a gear structure or may be structured in such a manner as to prevent the dial 6a from vibrating at one-notch intervals.

Moreover, a shutter button 6b is disposed as one of the operating elements 6. The shutter button 6b, which is depressible, is a two-stage switch that outputs a signal (input information) with different strokes as appropriate for a first stage or a second stage. In a case where a first-stage signal is outputted, the imaging apparatus 1 performs autofocus control. In a case where a second-stage signal is outputted, the imaging apparatus 1 captures an image.

Additionally, a touch panel 6c is disposed on the rear monitor 4 as one of the operating elements 6. The touch panel 6c receives a user's touch operation and outputs input information regarding a touched position or the like.

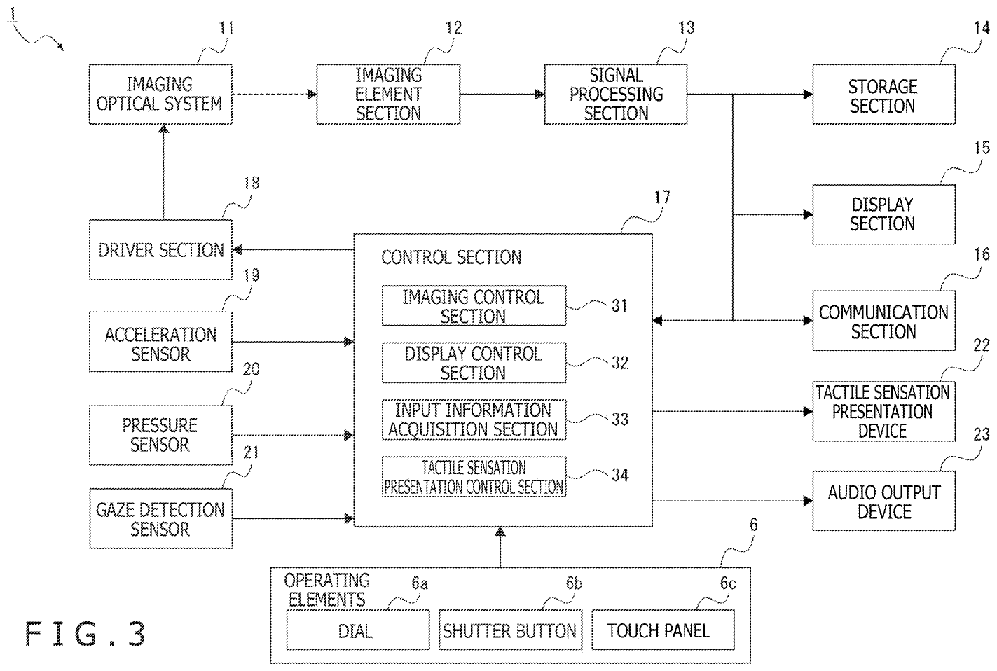

FIG. 3 illustrates an internal configuration of the above-described imaging apparatus 1.

In the imaging apparatus 1, light from the subject is incident on an imaging element section 12 through an imaging optical system 11.

The imaging optical system 11 includes various lenses, such as a zoom lens, a focus lens, and a condenser lens, an aperture mechanism, a zoom lens drive mechanism, and a focus lens drive mechanism. In some cases, a mechanical shutter (e.g., focal-plane shutter) is included in the imaging optical system 11.

The imaging element section 12 includes, for example, an image sensor of a CMOS (Complementary Metal Oxide Semiconductor) type or a CCD (Charge Coupled Device) type.

The imaging element section 12 performs, for example, a CDS (Correlated Double Sampling) process or an AGC (Automatic Gain Control) process on an electrical signal that is obtained by photoelectrically converting the light received by the image sensor, and further performs an A/D (Analog/Digital) conversion process on the resulting processed signal. Subsequently, the imaging element section 12 outputs a captured image signal, which is digital data, to a signal processing section 13.

The signal processing section 13 is configured as an image processing processor by using, for example, a DSP (Digital Signal Processor). The signal processing section 13 performs various signal processes on the inputted captured image signal. For example, the signal processing section 13 performs preprocessing, synchronization processing, YC generation processing, resolution conversion processing, and file formation processing.

In the preprocessing, for example, a clamp process and a correction process are performed on the captured image signal from the imaging element section 12. The clamp process is performed to clamp black levels of R, G, and B to predetermined levels. The correction process is performed on color channels of R, G, and B.

In the synchronization processing, a color separation process is performed on each pixel to generate image data having all color components of R, G, and B. For example, in the case of an image sensor that uses a color filter in the Bayer arrangement, demosaicing is performed as the color separation process.

In the YC generation processing, a luminance (Y) signal and a chrominance (C) signal are generated (separated) from R, G, and B image data.

In the resolution conversion processing, a resolution conversion process is performed on image data that has been subjected to various signal processes.

In the file formation processing, a file for recording or communication is generated by performing, for example, compression coding for recording or communication, formatting, and metadata generation and addition on image data that has been subjected, for example, to the various processes mentioned above.

For example, as a still-image file, an image file, for instance, in a JPEG (Joint Photographic Experts Group) format, a TIFF (Tagged Image File Format), or a GIF (Graphics Interchange Format) is generated. Further, it is also possible that an image file is generated, for example, in an MP4 format, which is used for MPEG-4-compliant video and audio recording. Moreover, it is also possible that an image file is generated as raw image data.

The signal processing section 13 generates metadata as the data including, for example, information regarding process parameters in the signal processing section 13, various control parameters acquired from a control section 17, information indicating an operating status of the imaging optical system 11 and the imaging element section 12, mode setting information, and information regarding date, time, and place.

A storage section 14 is, for example, a non-volatile memory and stores an image file (image data) processed by the signal processing section 13. Further, the storage section 14 also stores a database, device information, and environmental information, which will be described later in detail.

A display section 15 provides various displays to the camera operator and includes, for example, the rear monitor 4 and the EVF monitor 5a which are disposed on the housing of the imaging apparatus 1 as depicted in FIG. 1.

The display section 15 causes a display screen to provide various displays on the basis of instructions from the control section 17.

For example, the display section 15 causes the display screen to display an image based on the image data stored in the storage section 14.

Further, the display section 15 functions as a GUI (Graphical User Interface) to display, for example, various operating menus, icons, and messages on the basis of the instructions from the control section 17.

A communication section 16 establishes data communication and network communication with external equipment in a wired or wireless manner.

For example, the communication section 16 transmits out an image file, for example, to an external information processing apparatus, display apparatus, recording apparatus, and reproduction apparatus.

Further, the communication section 16 is able to function as a network communication section in order to establish various network communications, for example, communications with the Internet, a home network, and a LAN (Local Area Network), and transmit and receive various kinds of data to and from, for example, a networked server or terminal.

The control section 17 includes a microcomputer (arithmetic processing unit) that includes a CPU (Central Processing Unit), a ROM (Read Only Memory), and a RAM (Random Access Memory). The control section 17 functions as an imaging control apparatus that controls operations of the imaging apparatus 1.

The RAM serves as a work area for allowing the CPU to perform various data processes, and is used to temporarily store, for example, data and programs.

The ROM is used to store, for example, an OS (Operating System) for allowing the CPU to control various sections, an application program for performing various operations, firmware, and various setting information.

The various setting information includes, for example, communication setting information, setting information regarding imaging operations, and setting information regarding image processing. The setting information regarding the imaging operations includes, for example, the shutter speed, the Ev value, the F value, a curtain speed of a mechanical shutter or an electronic shutter, and mode settings.

The control section 17 is configured to function as an imaging control section 31, a display control section 32, an input information acquisition section 33, and a tactile sensation presentation control section 34.

The imaging control section 31 performs various kinds of control of image capture. For example, the imaging control section 31 controls various signal processing instructions in the signal processing section 13, imaging operations and recording operations based on user operations, and operations for reproducing recorded image files.

Further, the imaging control section 31 performs, for example, aperture mechanism motion control, shutter speed control of the imaging element section 12, autofocus control, focus lens and zoom lens drive control based, for instance, on manual focus operations and zoom operations, and exposure timing control.

The display control section 32 performs display control of the display section 15 (the rear monitor 4 and the EVF monitor 5a). For example, the display control section 32 causes the rear monitor 4 to display a captured image and a GUI for changing various settings.

The input information acquisition section 33 acquires the input information given to the operating elements 6. More specifically, the input information acquisition section 33 acquires, as the input information, signals that are outputted from the operating elements 6 operated by the user.

The tactile sensation presentation control section 34 exercises control to cause a tactile sensation presentation device 22 to provide tactile sensation presentation according to usage of the operating elements 6 based on the input information acquired by the input information acquisition section 33. It should be noted that a process performed by the tactile sensation presentation control section 34 will be described later.

Further, the control section 17 is connected to a driver section 18, an acceleration sensor 19, a pressure sensor 20, a gaze detection sensor 21, the tactile sensation presentation device 22, and an audio output device 23.

The driver section 18 includes, for example, a motor driver for a zoom lens drive motor, a motor driver for a focus lens drive motor, and a motor driver for an aperture mechanism motor.

According to instructions from the imaging control section 31, these motor drivers apply drive currents to the respective drivers, for example, thereby moving the focus lens and the zoom lens and opening or closing aperture blades of the aperture mechanism.

The acceleration sensor 19 detects rotational acceleration of the dial 6a and outputs a detection result to the control section 17.

The pressure sensor 20 detects a pressure applied to the shutter button 6b, that is, a downward pressure applied by the user to the shutter button 6b, and outputs a detection result to the control section 17.

The gaze detection sensor 21, which is disposed on the rear surface part 2b of the camera housing 2, detects a user's gaze direction and outputs a detection result to the control section 17.

The tactile sensation presentation device 22 provides tactile stimulation (performs tactile sensation presentation) to the user by generating, for example, a vibration. The tactile sensation presentation device 22 includes, for example, a piezoelectric element, an eccentric motor, a linear resonant actuator (LRA), or a voice coil motor (VCM).

The audio output device 23 outputs sound and includes, for example, a speaker or a piezoelectric element.

### 2. Change of Parameters

As described above, the imaging apparatus 1 is able to change the parameters such as the shutter speed, the Ev value, and the F value.

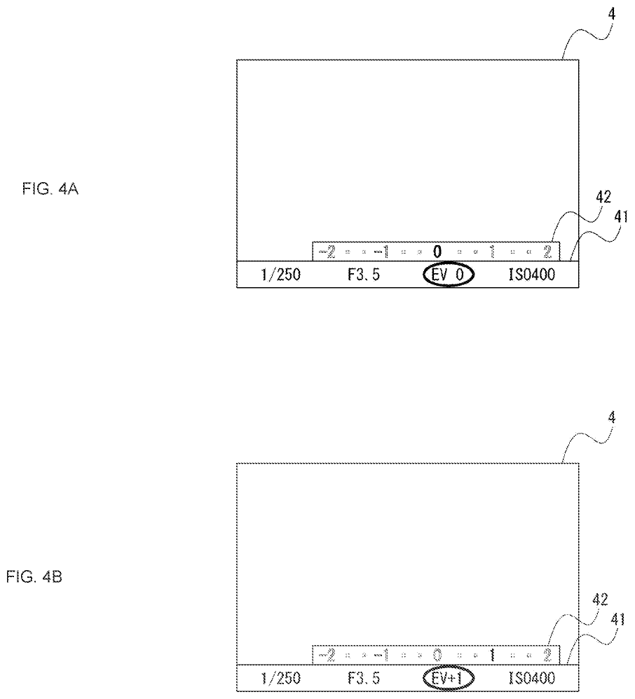

FIG. 4 is a set of diagrams illustrating a screen (GUI) that is displayed when the Ev value is to be changed. In the case where the Ev value, which is one of the parameters, is to be changed, the display control section 32 displays a parameter bar 41 on the rear monitor 4. The parameter bar 41 lists multiple parameters (the shutter speed, the F value, the Ev value, and an ISO value in the present example) as depicted in part A of FIG. 4. In this instance, the Ev value, which is one of the parameters listed in the parameter bar 41 and is to be changed, is highlighted.

Further, the display control section 32 displays a selection bar 42 above the parameter bar 41. The selection bar 42 indicates values that are selectable for the parameter highlighted in the parameter bar 41. In this instance, the present embodiment assumes that the selectable EV values are −3, −2.7, −2.3, −2, −1.7, −1.3, −1, −0.7, −0.3, 0, +0.3, +0.7, +1, +1.3, +1.7, +2, +2.3, +2.7, and +3. As described above, the selectable parameter values are set in multiple stages, and any of the multiple stages is to be selected.

Further, in the selection bar 42, integers among the selectable values, namely, −3, −2, −1, 0, +1, +2, and +3, are displayed directly as numerical values, whereas decimal fractions, namely, −2.7, −2.3, −1.7, −1.3, −0.7, −0.3, +0.3, +0.7, +1.3, +1.7, +2.3, and +2.7, are omitted and indicated by dots.

Moreover, the current setting value (0 in the present example), which is among multiple values listed in the selection bar 42, is highlighted.

Subsequently, when the dial 6a is operated to cause the input information acquisition section 33 to acquire the input information from the dial 6a, the imaging control section 31 changes the Ev value according to the input information. For example, in a case where one-notch operated input information is acquired three times to increase the Ev value, the imaging control section 31 changes the setting value to +1 by increasing it by three stages. That is, the imaging control section 31 sets +1 as the Ev value.

In this instance, as depicted in part B of FIG. 4, the display control section 32 highlights the setting value, which has been changed to +1 by the imaging control section 31, and thus prompts the user to visually confirm the changed Ev value.

In the above instance, the user changes the value of a parameter by operating the dial 6a while viewing the parameter bar 41 and the selection bar 42. However, in a situation where the user intends to change the value of a parameter, it is conceivable that the user may operate the dial 6a while viewing the EVF monitor 5a, operate the dial 6a while viewing a live view image displayed on the rear monitor 4, or operate the dial 6a without viewing any components of the display section 15.

When the user operates the dial 6a to change the value of a parameter without viewing or gazing at the parameter bar 41 or the selection bar 42 as described above, the user operates the dial 6a while relying only on tactile stimulation generated upon the operation of the dial 6a. As a result, ease of use (usability) is poor.

To cope with this problem, the tactile sensation presentation control section 34 exercises control to cause the tactile sensation presentation device 22 to provide tactile sensation presentation according to the usage of the operating elements 6 based on the input information, which leads to improved usability.

The following describes an outline of a tactile sensation presentation control process performed by the tactile sensation presentation control section 34 and then explains some specific examples.

### 3. Overview of Tactile Sensation Presentation Process

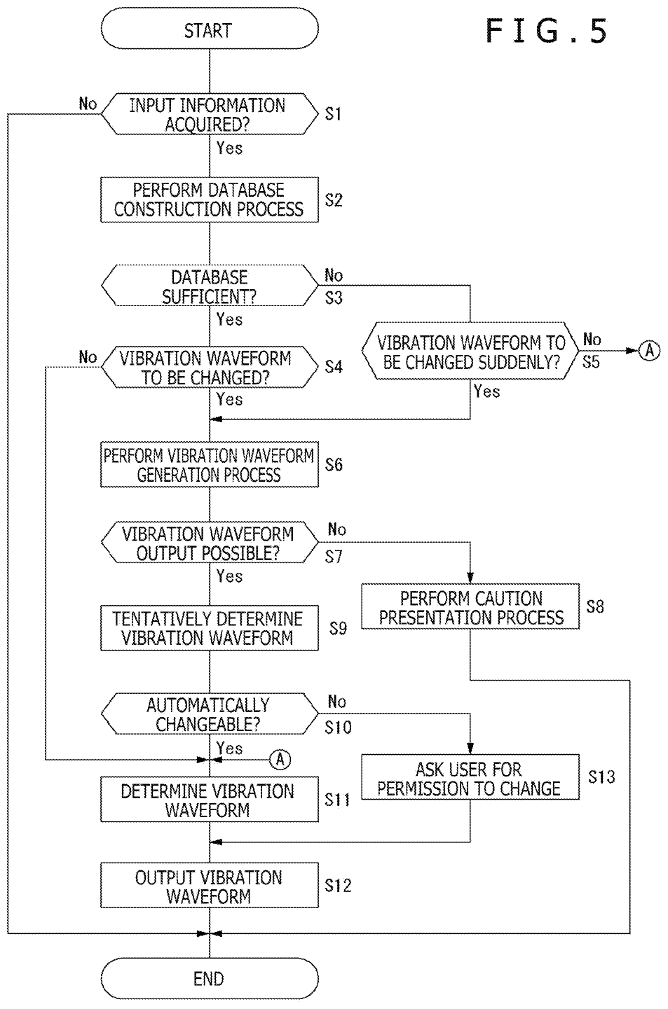

FIG. 5 is a flowchart illustrating a flow of the tactile sensation presentation control process. As depicted in FIG. 5, when the tactile sensation presentation control process starts, the tactile sensation presentation control section 34 determines in step S1 whether the input information has been acquired by the input information acquisition section 33. In a case where the input information has not been acquired yet (“NO” at step S1), the tactile sensation presentation control section 34 terminates the tactile sensation presentation control process.

On the other hand, in a case where the input information has been acquired (“YES” at step S1), the tactile sensation presentation control section 34 proceeds to step S2 and performs a database construction process of constructing a database regarding the usage. It should be noted that the database may be constructed for each imaging apparatus 1 or may be constructed for each user if the user of the imaging apparatus 1 can be identified.

The database stores not only the setting information based on the input information but also the environmental information and the device information. It should be noted that the setting information, the environmental information, and the device information obtained at the time of input information acquisition indicate a situation where the operating elements 6 for outputting the input information are used. Therefore, it can be said that such items of information indicate the usage of the operating elements 6.

The setting information includes, for example, a frequency of parameter selection (parameter selection count), a range of parameter selection, and movement speeds of the operating elements 6, which are set based on the input information by the imaging control section 31. The setting information is calculated based on values that are set by the imaging control section 31.

The environmental information includes, for example, an imaging situation where the input information is acquired, a subject, and a mode. The environmental information is stored in the storage section 14.

The device information includes, for example, information regarding employed lenses. The device information is stored in the storage section 14.

It should be noted that the above-mentioned setting information, environmental information, and device information are merely examples. The database may include the following items of information or may exclude some of them.

The tactile sensation presentation control section 34 acquires, in the database construction process, the setting information, the environmental information, and the device information, which are obtained at the time of input information acquisition, associates the acquired items of information with each other, and stores the resulting information in the database. Further, in a case where a vibration waveform is generated in a later-described vibration waveform generation process (step S6), the tactile sensation presentation control section 34 stores information regarding the generated vibration waveform in association with the setting information, the environmental information, and the device information.

As described above, the tactile sensation presentation control section 34 constructs the database each time the input information is acquired.

Next, in step S3, the tactile sensation presentation control section 34 determines whether the database has sufficiently been constructed. In this instance, the determination is made depending, for example, on whether reliability (certainty) of the database is equal to or higher than a threshold set in advance. Here, it is conceivable that the reliability is a value based, for example, on the number of samplings of the input information.

Subsequently, in a case where the database has sufficiently been constructed (“YES” at step S3), the tactile sensation presentation control section 34 proceeds to step S4 and determines whether the vibration waveform needs to be changed. In this instance, the determination is made regarding whether it is necessary to change the vibration waveform that is associated with the database in correspondence with the acquired input information.

On the other hand, in a case where the database has not sufficiently been constructed yet (“NO” at step S3), the tactile sensation presentation control section 34 proceeds to step S5 and determines whether the vibration waveform needs to be suddenly changed. In this instance, as described in detail later, the determination is made regarding whether the user might feel multiple vibrations connected to one another as a single vibration in a case where vibrations (tactile stimulation) are successively provided with respect to multiple pieces of input information.

Subsequently, in a case where the vibration waveform need not be changed (“NO” at step S4) or in a case where the vibration waveform need not be suddenly changed (“NO” at step S5), the tactile sensation presentation control section 34 proceeds to step S11.

On the other hand, in a case where the vibration waveform needs to be changed (“YES” at step S4) or in a case where the vibration waveform needs to be suddenly changed (“YES” at step S5), the tactile sensation presentation control section 34 proceeds to step S6 and performs the vibration waveform generation process of generating the vibration waveform that corresponds to at least any of the setting information, the environmental information, or the device information. Then, in step S7, the tactile sensation presentation control section 34 determines whether a vibration based on the vibration waveform generated in step S6 can be outputted by the tactile sensation presentation device 22.

In a case where the vibration based on the generated vibration waveform cannot be outputted by the tactile sensation presentation device 22 (“NO” at step S7), the tactile sensation presentation control section 34 proceeds to step S8 and presents a caution, for example, by causing the display section 15 to indicate that the vibration cannot be provided or by causing the audio output device 23 to generate a relevant output. Upon completion of step S8, the tactile sensation presentation control section 34 terminates the tactile sensation presentation control process.

On the other hand, in a case where the vibration based on the generated vibration waveform can be outputted by the tactile sensation presentation device 22 (“YES” at step S7), the tactile sensation presentation control section 34 proceeds to step S9 and tentatively decides on the vibration waveform generated in step S6.

Subsequently, in step S10, the tactile sensation presentation control section 34 determines whether the vibration waveform is set to be automatically changeable. It should be noted that the imaging apparatus 1 is able to preset whether the vibration waveform is automatically changeable.

Then, in a case where the vibration waveform is set to be automatically changeable (“YES” at step S10), the tactile sensation presentation control section 34 proceeds to step S11 and decides (finally decides) on the vibration waveform tentatively decided on in step S9. Further, in the case where the vibration waveform need not be changed (“NO” at step S4), the tactile sensation presentation control section 34 accesses the database to read out the vibration waveform associated with at least any of the setting information, the environmental information, or the device information and decides on the read vibration waveform. Moreover, in the case where the vibration waveform need not be suddenly changed (“NO” at step S5), the tactile sensation presentation control section 34 accesses the storage section 14 to read out a default vibration waveform associated with at least any of the setting information, the environmental information, or the device information and decides on the read default vibration waveform.

Subsequently, in step S12, the tactile sensation presentation control section 34 exercises control to cause the tactile sensation presentation device 22 to output a vibration based on the vibration waveform decided on in step S11, and then terminates the tactile sensation presentation control process.

On the other hand, in a case where the vibration waveform is set to be not automatically changeable (“NO” at step S10), the tactile sensation presentation control section 34 proceeds to step S13 and causes the rear monitor 4 to display a user interface (UI) for asking the user for permission to change the vibration waveform. Then, in a case where the user's permission is obtained, the tactile sensation presentation control section 34 proceeds to step S12. It should be noted that, in a case where the user's permission is not obtained, the tactile sensation presentation control section 34 terminates the tactile sensation presentation process. However, step S13 need not necessarily be performed in the tactile sensation presentation process, and may be performed at a different time point.

### 4. Embodiments

Specific examples of the above-described tactile sensation presentation control process will now be described.

### 4.1 First Embodiment

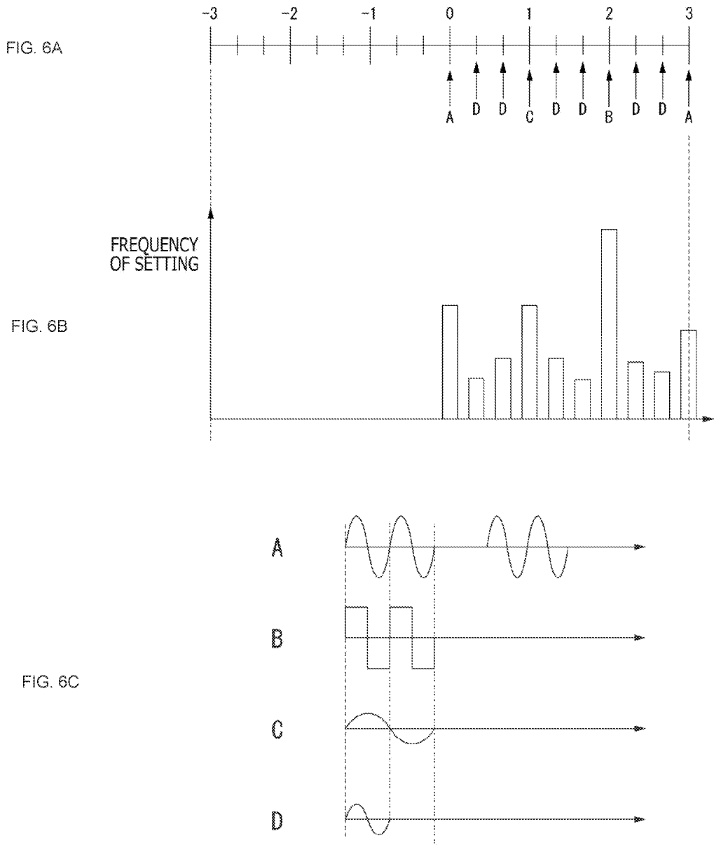

FIG. 6 is a set of diagrams illustrating the vibration waveform in a first embodiment. Part A of FIG. 6 is a diagram illustrating the vibration waveform that is outputted for each Ev value. Part B of FIG. 6 is a diagram illustrating a frequency of setting of the Ev value. Part C of FIG. 6 is a diagram illustrating a vibration waveform.

The first embodiment represents an example where parameter setting values (setting range) frequently used by the user are learned and tactile sensation presentation is provided on the basis of a learning result. Further, the first embodiment will be described with reference to the case of changing the Ev value as a parameter.

As depicted in part A of FIG. 6, the Ev value can be set to any value of multiple different stages within a range from −3 to +3.

Now, it is assumed that, for example, the Ev value is set by the user at a setting frequency (setting count) indicated in part B of FIG. 6. As depicted in part B of FIG. 6, the Ev value is set only within a range (setting range) from 0 to +3 and is not set within a range from −0.3 to −3. Further, within the set range (0 to +3), the Ev value is frequently set to integers, namely, 0, +1, +2, and +3, and is infrequently set to decimal fractions, namely, 0.3, 0.7, 1.3, 1.7, 2.3, and 2.7. Moreover, within the setting range (0 to +3), the Ev value is most frequently set to +2.

Now, it is assumed that the above usage (setting information) is registered in the database in the earlier-described step S3. That is, it is assumed that the tactile sensation presentation control section 34 has learned, for example, the setting range of the Ev value set through the dial 6a. In this case, in the vibration waveform generation process in the earlier-described step S6, the tactile sensation presentation control section 34 generates any of vibration waveforms A to D as the vibration waveform obtained at the time of change to each Ev value, as depicted in parts A and C of FIG. 6, on the basis of the learning result, that is, the database.

For example, the tactile sensation presentation control section 34 generates the vibration waveform A with respect to the input information indicating that the Ev values at both ends of the setting range are to be changed to 0 and +3. Further, the tactile sensation presentation control section 34 generates the vibration waveform B with respect to the input information indicating that the most frequently set Ev value within the setting range is to be changed to +2. Further, the tactile sensation presentation control section 34 generates the vibration waveform C with respect to the input information indicating that the Ev value within the setting range is an integer and that the Ev value for which the vibration waveforms A and B are not generated is to be changed to +1. Moreover, the tactile sensation presentation control section 34 generates the vibration waveform D with respect to the input information indicating that the Ev value within the setting range is not an integer (is a decimal fraction) and is to be changed to the Ev value for which the vibration waveforms A to C are not generated.

Here, the vibration V(t) outputted from the tactile sensation presentation device 22 can be expressed, for example, as indicated below.

V(t)=Aexp(−Bt)sin(2πft) (1)

It should be noted that A is a strength of vibration (amplitude), B is a frequency of vibration, and C is an attenuation rate of vibration.

Hence, when the vibration waveform is to be generated, it is sufficient to determine A, B, and C in Equation (1) above.

However, the vibration expressed in Equation (1) is merely an example. Alternatively, a vibration having multiple frequency components may be synthesized.

In the example of part C in FIG. 6, the vibration waveform A is higher in strength than the other vibration waveforms B to D, higher in frequency than the vibration waveform C, longer in output time than the vibration waveforms B to D, and larger in the number of outputs than the vibration waveforms B to D as the number of outputs of the vibration waveform A is two. Therefore, the vibration waveform A is able to provide a stronger vibration to the user than the other vibration waveforms B to D.

Further, the vibration waveform B is not a vibration waveform as expressed in Equation (1) but is the vibration waveform of a rectangular wave.

Further, the vibration waveform C is lower in strength and shorter in output time than the vibration waveform A.

Moreover, the vibration waveform D is lower in strength than the vibration waveforms A and C and higher in frequency and shorter in output time than the vibration waveform C.

As described above, the tactile sensation presentation control section 34 generates the vibration waveforms A to D based on the database and causes the tactile sensation presentation device 22 to output vibrations corresponding to the vibration waveforms A to D. That is, the tactile sensation presentation control section 34 exercises control to provide tactile sensation presentation on the basis of the learning result.

For example, in a case where the acquired input information indicates that the Ev values at both ends of the setting range are to be set (changed) to 0 or +3, the tactile sensation presentation control section 34 exercises control in such a manner that a strong vibration like the vibration based on the vibration waveform A is repeatedly provided multiple times. That is, the tactile sensation presentation control section 34 is able to remind the user of an end of the setting range used by the user, by exercising control to present a tactile sensation indicating the end of the setting range. Consequently, upon receiving a vibration based on the vibration waveform A, the user is able to easily recognize that performing an operation for persistently moving the dial 6a in the present direction changes the Ev value to a value within a range that has not been set by the user.

Further, in a case where the acquired input information corresponds to the value +2, which is most frequently set, the tactile sensation presentation control section 34 presents a tactile sensation different from that in a case where the acquired input information corresponds to the other values. More specifically, in a case where the Ev value most frequently set within the setting range is set to +2, the tactile sensation presentation control section 34 exercises control in such a manner that a vibration based on the vibration waveform B, which is different from the other vibration waveforms, is provided to the user, and is thus able to easily make the user recognize that the Ev value has been changed to the most frequently set Ev value.

Moreover, in a case where the acquired input information corresponds to an integer as the Ev value, the tactile sensation presentation control section 34 presents a tactile sensation different from that in a case where the acquired input information corresponds to a non-integer value.

More specifically, in a case where the Ev value is set to an integer within the setting range, the tactile sensation presentation control section 34 exercises control to provide a vibration like the vibration based on the vibration waveform C, which is stronger than in the case where the Ev value is a decimal fraction, and thus makes it easier to recognize that the Ev value has been changed to an integer.

Meanwhile, in a case where the Ev value is set to a decimal fraction, the tactile sensation presentation control section 34 exercises control to provide a vibration weaker than the other vibrations, such as the vibration based on the vibration waveform D, and is thus able to reduce the possibility that, in the case of continuously operating the dial 6a, multiple vibrations are connected to one another and recognized as a single vibration.

Further, the tactile sensation presentation control section 34 exercises control to provide a vibration (vibration waveforms A to D) that varies with the Ev value set within the setting range, and is thus able to make it easy for the user to recognize which setting value corresponds to a specific operation.

It should be noted that the above-described vibration waveforms A to D are merely examples. The vibration waveforms may alternatively be other than the vibration waveforms A to D. Further, the tactile sensation presentation control section 34 may generate the vibration waveforms that are based not only on the setting information but also on the environmental information and the device information.

In the first embodiment, the environmental information and the device information include, for example, a weight and a size of the imaging apparatus 1, the imaging environment, setting value intervals, movement speeds of the operating elements 6, hardness of the operating elements 6, acceleration during operation of the operating elements 6, and user perception conditions.

Further, the user perception conditions include, for example, an age, a type of disease, a gender, and a body shape.

As described above, when the environmental information and the device information are taken into consideration, the vibration waveforms for increasing the strength of all vibrations can be generated, for example, for elderly users who probably have decreased sensitivity to tactile sensation.

Further, for users who suffer from a specific disease and might have decreased sensitivity to a specific frequency, the vibration waveforms without the specific frequency can be generated.

Further, the vibration waveforms for decreasing the strength of all vibrations can be generated for female users who are more sensitive to stimulation than male users.

Moreover, the vibration waveforms for increasing the strength of all vibrations can be generated for fat users who have decreased sensitivity to vibrations because of thick fingers used to operate the operating elements 6.

### 4.2 Second Embodiment

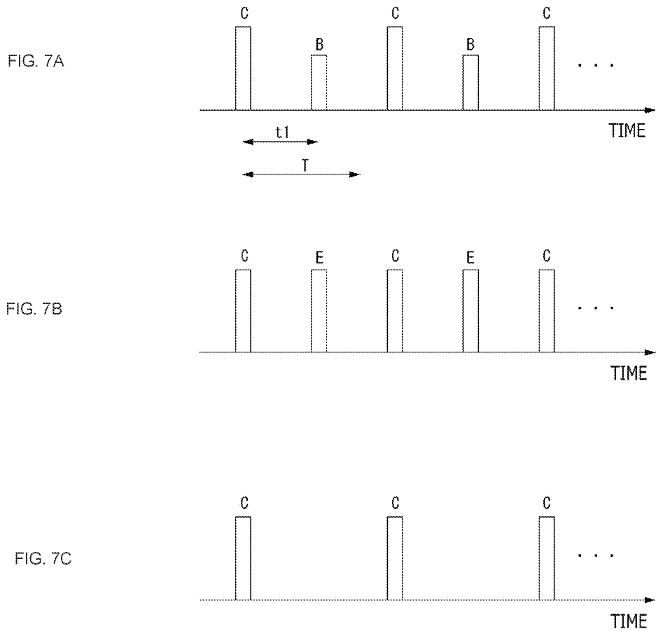

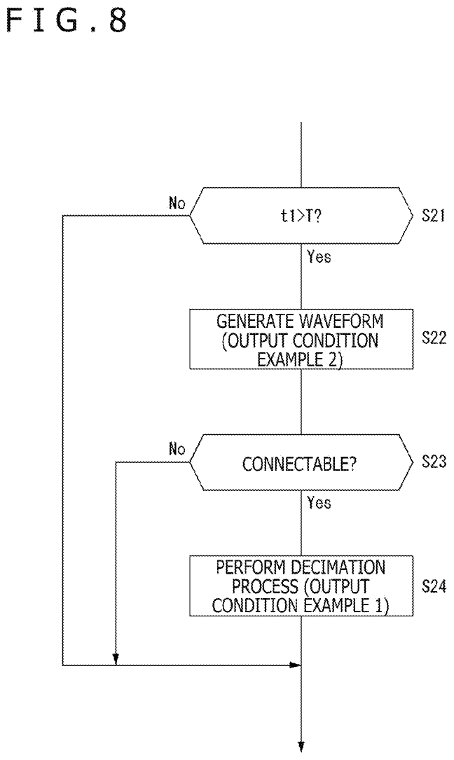

FIG. 7 is a set of diagrams illustrating the vibration waveform in a second embodiment. Part A of FIG. 7 is a diagram illustrating a sequence of vibration waveforms over time. Part B of FIG. 7 is a diagram illustrating the sequence of vibration waveforms over time in a case where a vibration waveform change is applied. Part C of FIG. 7 is a diagram illustrating the sequence of vibration waveforms over time in a case where vibration waveform decimation is performed. FIG. 8 is a flowchart illustrating a flow of processing in the second embodiment .

The second embodiment represents an example where learning is performed on the speed at which the user operates the dial 6a, in a case where a single vibration might be provided by allowing one vibration to be connected to another or allowing multiple vibrations to be connected to one another if the user quickly operates the dial 6a.

In a case where the dial 6a is operated to rotate and the input information is successively outputted from the dial 6a, it is assumed that the tactile sensation presentation device 22 repeatedly outputs vibrations based on the vibration waveform C and the vibration waveform B in the order of the vibration waveform C, the vibration waveform B, the vibration waveform C, the vibration waveform B, and so on as depicted in part A of FIG. 7, for example.

Then, in a case, for example, where a time interval (presentation interval) t1 between an instant at which the input information corresponding to the vibration waveform C is acquired and an instant at which the input information corresponding to the vibration waveform B is acquired is shorter than a perception limit time T for two-point discrimination (t1<T), the tactile sensation presentation control section 34 decimates the vibration waveform (vibration) corresponding to the later-acquired input information or switches to a different vibration waveform.

More specifically, in step S21 of FIG. 8, the tactile sensation presentation control section 34 determines whether the time t1 is shorter (less) than the perception limit time T. It should be noted that the above-mentioned step S21 is performed in step S4 of FIG. 5. That is, here, the tactile sensation presentation control section 34 determines whether the time t1 is shorter than the perception limit time T and the vibration waveform needs to be changed.

Then, in a case where the time t1 is shorter than the perception limit time T (“YES” at step S21), the tactile sensation presentation control section 34 proceeds to step S22 and switches from the vibration waveform B corresponding to the input information to a vibration waveform E as depicted in part B of FIG. 7. For example, the tactile sensation presentation control section 34 generates the vibration waveform E by increasing the strength of vibration or shortening a waveform exposure time as compared with the vibration waveform B or by switching to a frequency to which a user's hand is highly perceptually sensitive.

Further, in step S23, the tactile sensation presentation control section 34 determines whether the vibration waveform may possibly be connected to the previous vibration (vibration waveform C) even after switching to the vibration waveform generated in step S22. Then, in a case where the vibration waveform may possibly be connected to the previous vibration (“YES” at step S23), the tactile sensation presentation control section 34 proceeds to step S24 and performs a decimation process in such a manner as not to provide the vibration corresponding to the acquired input information, as depicted in part C of FIG. 7. More specifically, the tactile sensation presentation control section 34 inhibits the tactile sensation presentation device 22 from generating a vibration output, by discarding the vibration waveform E, which corresponds to the acquired input information.

It should be noted that steps S22 to S24 are executed during the vibration waveform generation process, which is performed in the earlier-described step S6.

As described above, in a case where an already outputted vibration may possibly be connected to the vibration corresponding to the currently acquired input information, the relevant vibration waveform is changed or decimated as needed to prevent the user from feeling as if multiple vibrations are connected to each other. This reduces the possibility of the user making erroneous recognition due to the connection of the multiple vibrations.

### 4.3 Third Embodiment

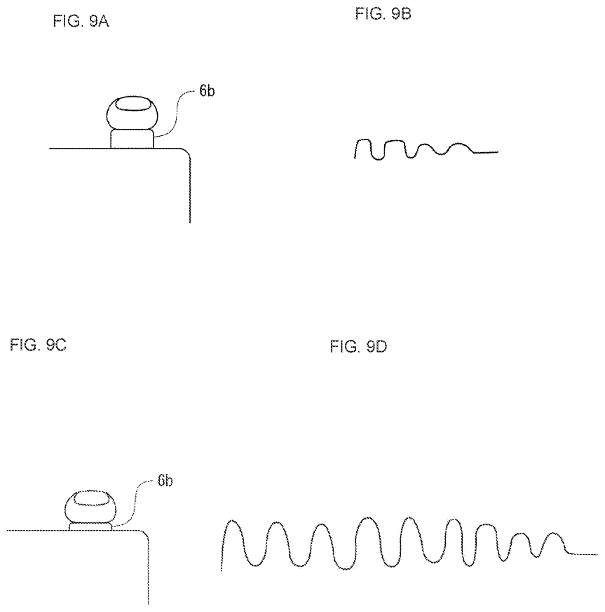

FIG. 9 is a set of diagrams illustrating the vibration waveform in a third embodiment. Part A of FIG. 9 is a diagram illustrating a state where the shutter button 6b is half-depressed. Part B of FIG. 9 is a diagram illustrating an example of the vibration waveform that is generated when the shutter button 6b is half-depressed. Part C of FIG. 9 is a diagram illustrating a state where the shutter button 6b is fully depressed. Part D of FIG. 9 is a diagram illustrating an example of the vibration waveform that is generated when the shutter button 6b is fully depressed.

The third embodiment represents an example where vibration waveform generation is performed according to the pressure applied to the shutter button 6b when it is depressed by the user.

As depicted in part A of FIG. 9, while the shutter button 6b is half-depressed, the shutter button 6b outputs the first-stage signal (input information) indicative of a half-depressed state to the control section 17 at predetermined time intervals. In this instance, the control section 17 acquires a pressure value from the pressure sensor 20.

Subsequently, when the first-stage signal is acquired, the tactile sensation presentation control section 34 generates a vibration waveform based on the pressure measured by the pressure sensor, such as the vibration waveform depicted in part B of FIG. 9.

Further, as depicted in pact C of FIG. 9, while the shutter button 6b is fully depressed, the shutter button 6b outputs the second-stage signal (input information) indicative of a fully-depressed state to the control section 17 at predetermined time intervals. In this instance, the control section 17 acquires a pressure value from the pressure sensor.

Subsequently, when the second-stage signal is acquired, the tactile sensation presentation control section 34 generates a vibration waveform based on the pressure measured by the pressure sensor, such as the vibration waveform depicted in part D of FIG. 9.

In the above situation, when the shutter button 6b is fully depressed, the shutter button 6b is depressed at a higher pressure than when it is half-depressed. Further, the higher the pressure (pressure sensation), the lower the likelihood of people feeling a vibration. Therefore, when the shutter button 6b is fully depressed (at a relatively high pressure), the resulting generated vibration waveform is higher in strength than when the shutter button 6b is half-depressed (at a relatively low pressure).

As described above, a vibration corresponding to the pressure can be provided to the user by increasing the strength of vibration according to the pressure. This reduces a difference in the feel of vibration that may be caused by a pressure change.

### 4.4 Fourth Embodiment

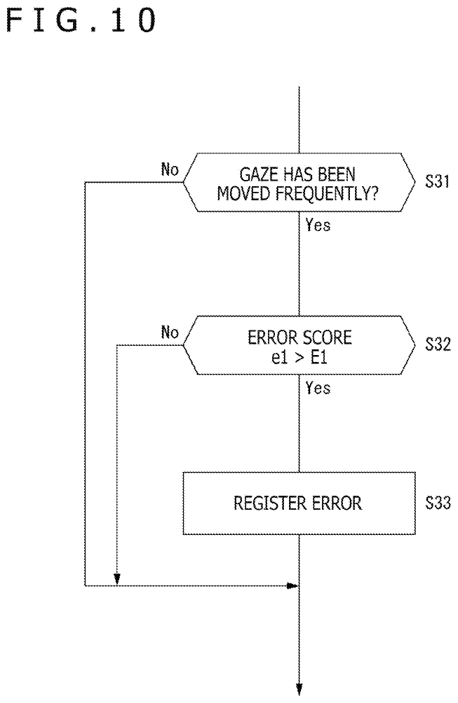

FIG. 10 is a flowchart illustrating the flow of the database construction process in a fourth embodiment.

The fourth embodiment represents an example where the database is constructed by learning a user error situation.

When changing a parameter, for example, users may operate the dial 6a to change the parameter without viewing the selection bar 42, and then move the gaze to the selection bar 42, or may operate the dial 6a to change the parameter, and then move the gaze from the EVF monitor 5a to the rear monitor 4. The users who frequently move the gaze to the selection bar 42 after displaying the parameter in the above-mentioned manner are likely to erroneously set the parameter.

In view of the above situation, in step S31, the tactile sensation presentation control section 34 determines, based on the result of detection by the gaze detection sensor 21, whether the gaze has been moved to the selection bar 42 after the input of the input information. In a case where the gaze has been moved to the selection bar 42 after the input of the input information (step S31), the tactile sensation presentation control section 34 increments an error score e1 by one, proceeds to step S32, and determines whether the error score e1 is higher than an error threshold E1. It should be noted that the error threshold E1 is a preset value indicating an error-prone situation.

Then, in a case where the error score e1 is higher than the error threshold E1 (“YES” at step S32), the tactile sensation presentation control section 34 proceeds to step S33 and registers in the database error information indicating an error situation where an error has occurred in the operation of the dial 6a for a parameter change.

It should be noted that steps S31 to S33 are executed when the database construction process is performed in the earlier-described step S2.

Subsequently, in a case where the error information is registered in the database, in the earlier-described step S6, the tactile sensation presentation control section 34 generates a predetermined vibration waveform corresponding to the vibration that is outputted when a parameter change operation is performed, and stores the generated vibration waveform in the database in association with the error information.

Consequently, upon acquiring the input information corresponding to the parameter change operation, the tactile sensation presentation control section 34 is able to cause the tactile sensation presentation device 22 to output a vibration based on the vibration waveform associated with the error information. This enables the user to make a parameter change depending on the vibration, and saves the user the trouble of visually confirming the selection bar 42.

Further, in a case where the error score represents the number of times an operation beyond the setting range has been performed, and is higher than a preset error threshold, the tactile sensation presentation control section 34 may generate a vibration waveform indicating that the operation beyond the setting range has been performed, and cause the tactile sensation presentation device 22 to output a vibration based on the generated vibration waveform.

Moreover, in a case where the error score represents the number of times an operation performed beyond the setting range has fallen back into the setting range, and is higher than a preset error threshold, the tactile sensation presentation control section 34 may generate a vibration waveform indicating that the operation beyond the setting range has been performed, and cause the tactile sensation presentation device 22 to output a vibration based on the generated vibration waveform.

### 4.5 Fifth Embodiment

A fifth embodiment represents an example where tactile sensation presentation is performed by learning an environmental situation.

As described earlier, the tactile sensation presentation control section 34 is able to generate a vibration waveform based not only on the input information but also on the environmental information.

For example, a low shutter speed is set in a dark environment. Accordingly, in a case where the environmental information indicating the dark environment is acquired and the shutter speed is changed as a parameter, the tactile sensation presentation control section 34 generates a vibration waveform for generating an output within a range where the shutter speed is assumed to be low. Subsequently, when an operation is performed to change the shutter speed to a value within the range, the tactile sensation presentation control section 34 exercises control to output a vibration based on the generated vibration waveform from the tactile sensation presentation device 22.

Further, in a case where the subject moves, a high shutter speed is set. Accordingly, in a case where the environmental information indicative of a moving subject is acquired and the shutter speed is changed as a parameter, the tactile sensation presentation control section 34 generates a vibration waveform for generating an output within a range where the shutter speed is assumed to be high. Subsequently, when an operation is performed to change the shutter speed to a value within the range, the tactile sensation presentation control section 34 exercises control to output a vibration based on the generated vibration waveform from the tactile sensation presentation device 22.

Meanwhile, in a case where a portrait mode is selected, the F value should be set to a value for blurring the background. Accordingly, in a case where the portrait mode is selected and the F value is changed as a parameter, the tactile sensation presentation control section 34 generates a vibration waveform for generating an output at the F value that is set for blurring the background. Subsequently, when an operation is performed to make an F value change for blurring the background, the tactile sensation presentation control section 34 exercises control to output a vibration based on the generated vibration waveform from the tactile sensation presentation device 22.

As described above, the tactile sensation presentation control section 34 is able to report an optimal setting value to the user by generating a vibration waveform corresponding to the environmental information (usage environment) obtained at the time of operation of an operating element 6, and then imparting a vibration based on the generated vibration waveform.

Additionally, the tactile sensation presentation control section 34 may exercise control to provide tactile stimulation by generating a vibration waveform according to a history of camera usage by the user and an imaging skill of the user. In this case, it is sufficient if the history of camera usage by the user is calculated from a length of camera usage time. Further, it is sufficient if the imaging skill is determined based on a history of deletion of captured images and the number of captured images. In this case, it is sufficient if the skill is determined by using an image deletion rate as an evaluation value, for example. Alternatively, the history of camera usage by the user and the imaging skill of the user may be inputted by the user.

### 4.6 Sixth Embodiment

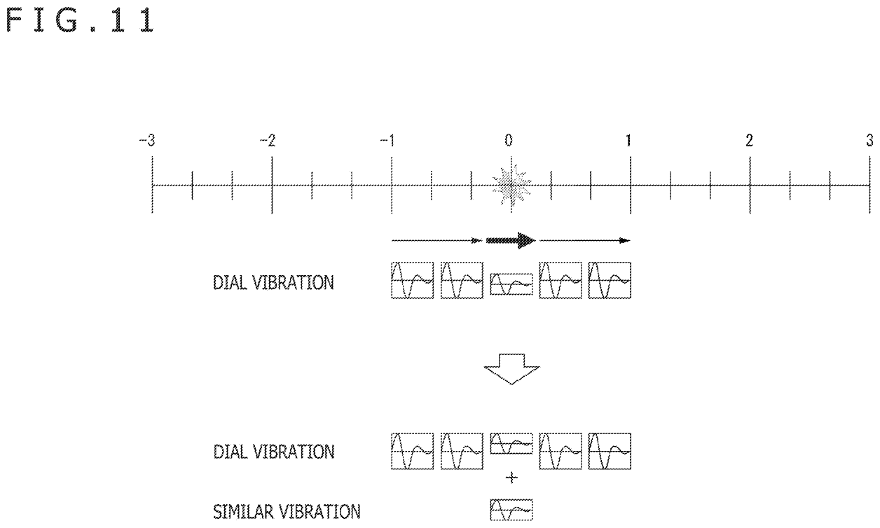

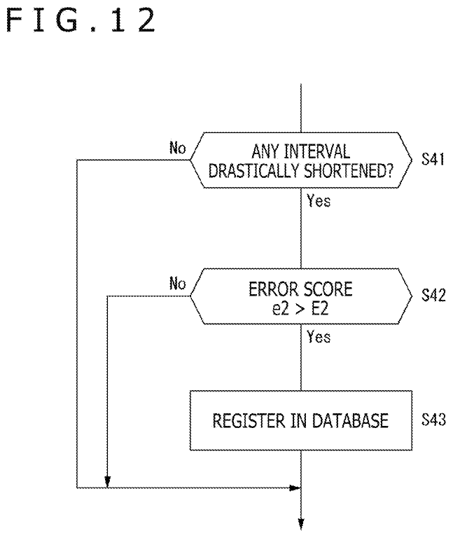

FIG. 11 is a diagram illustrating the vibration waveform in a sixth embodiment. FIG. 12 is a flowchart illustrating a flow of the database construction process in the sixth embodiment .

The sixth embodiment represents an example where the vibration waveform is generated in a case where a dial vibration is weakened due to aging. Additionally, the following description of the sixth embodiment deals with a case where the Ev value is changed as a parameter.

When the dial 6a becomes aged due to long-term use, the force required to cause the ball fitted into a groove in the dial 6a to move out of the groove may be decreased to increase the speed at which the ball passes through the groove. That is, as regards the dial 6a, the speed of input at a specific spot (place) increases due to aging.

For example, in a case where the Ev value is changed from −1 to +1 as depicted in FIG. 11, the input speed of only an operation related to an Ev value of 0 increases. Therefore, the dial vibration received from the dial 6a decreases.

In such a case, as depicted in FIG. 12, the tactile sensation presentation control section 34 determines in step S41 whether any particular input information acquisition interval is shorter than the other input information acquisition intervals. In a case where the result of determination indicates that there is a relatively short input information acquisition interval, the tactile sensation presentation control section 34 increments an error score e2 by one, then proceeds to step S42, and determines whether the error score e2 is higher than an error threshold E2. It should be noted that the error threshold E2 is a preset value indicating an error-prone situation caused by an interval shortened due to aging.

Subsequently, in step S43, the tactile sensation presentation control section 34 registers the relevant data in the database such that a similar vibration occurs at an error occurrence spot. The similar vibration is an auxiliary vibration (vibration waveform) that is to be added to the dial vibration at the error occurrence spot as depicted in FIG. 11 in order to provide the user with a vibration equivalent to the dial vibrations at the other spots.

It should be noted that steps S41 to S43 are executed when the database construction process is performed in the earlier-described step S2.

Subsequently, in a case where the error information is registered in the database, in the earlier-described step S6, the tactile sensation presentation control section 34 generates a predetermined vibration waveform corresponding to the similar vibration that is outputted when an operation is performed with respect the error occurrence spot, and stores the generated vibration waveform in the database in association with the error information.

Consequently, in a case where the dial 6a is found to be aged, or more specifically, in a case where the speed of operation is increased because the dial vibration is weakened due to aging, the imaging apparatus 1 provides the similar vibration at a spot where the speed of operation is increased, and is thus able to compensate for aging and reduce discomfort caused by a change in the feel of dial vibration.

### 4.7 Seventh Embodiment

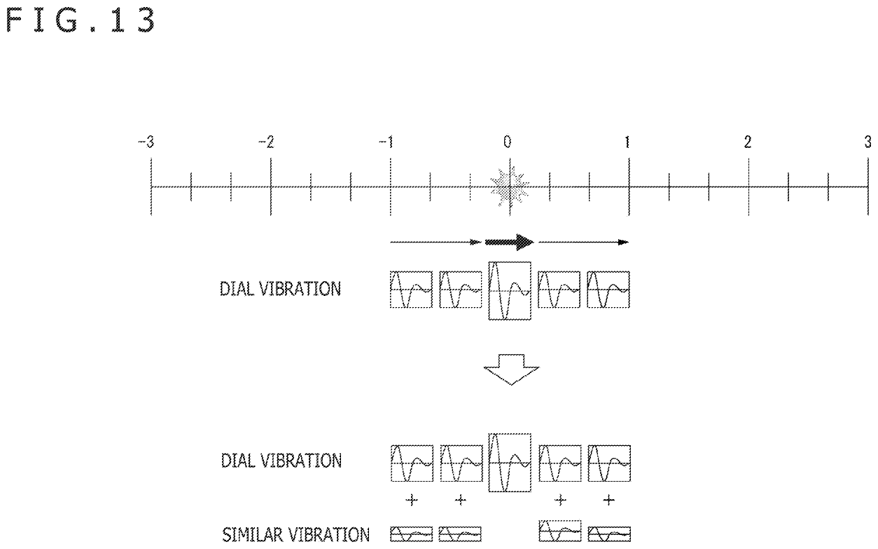

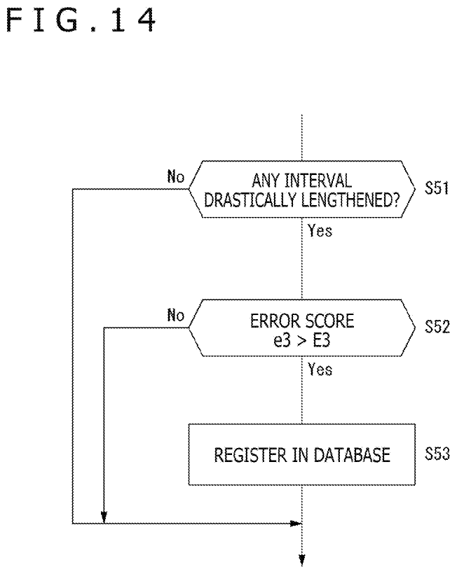

FIG. 13 is a diagram illustrating how tactile sensation presentation is performed in a case where the dial vibration is strengthened due to aging. FIG. 14 is a flowchart illustrating a flow of the database construction process.

A seventh embodiment represents an example where tactile sensation presentation is performed in the case where the dial vibration is strengthened due to aging. Additionally, the following description of the seventh embodiment deals with a case where the Ev value is changed as a parameter.

When the dial 6a becomes aged due to long-term use, the force required to cause the ball fitted into a groove in the dial 6a to move out of the groove may be increased to decrease the speed at which the ball passes through the groove. That is, as regards the dial 6a, the speed of input at a specific spot (place) decreases due to aging.

For example, in a case where the Ev value is changed from −1 to +1 as depicted in FIG. 13, the input speed of only an operation related to an Ev value of 0 decreases. Therefore, the dial vibration received from the dial 6a increases.

In such a case, as depicted in FIG. 14, the tactile sensation presentation control section 34 determines in step S51 whether any particular input information acquisition interval is longer than the other input information acquisition intervals. In a case where the result of determination indicates that there is a relatively long input information acquisition interval, the tactile sensation presentation control section 34 increments an error score e3 by one, then proceeds to step S52, and determines whether the error score e3 is higher than an error threshold E3. It should be noted that the error threshold E3 is a preset value indicating an error-prone situation caused by an interval lengthened due to aging.

Subsequently, in step S53, the tactile sensation presentation control section 34 registers the relevant data in the database such that a similar vibration occurs at spots other than an error occurrence spot. As depicted in FIG. 13, the similar vibration here is an auxiliary vibration (vibration waveform) that is to be added to the dial vibration at spots where no error has occurred, for the purpose of providing the user with a vibration equivalent to the dial vibration at the error occurrence spot.

It should be noted that steps S51 to S53 are executed when the database construction process is performed in the earlier-described step S2.

Subsequently, in a case where the error information is registered in the database, in the earlier-described step S6, the tactile sensation presentation control section 34 generates a predetermined vibration waveform corresponding to the similar vibration that is outputted when an operation is performed with respect to the spots other than the error occurrence spot, and stores the generated vibration waveform in the database in association with the error information.

Consequently, in a case where the dial 6a is found to be aged, or more specifically, in a case where the speed of operation is decreased because the dial vibration is strengthened due to aging, the imaging apparatus 1 provides the similar vibration at a spot where the speed of operation is decreased, and is thus able to compensate for aging and reduce discomfort caused by a change in the feel of dial vibration.

### 4.8 Eighth Embodiment

An eighth embodiment represents an example where tactile sensation presentation is performed in a case where the shutter button 6b is aged.

When the shutter button 6b becomes aged due to long-term use, the shutter button 6b loses strength. Consequently, even if the pressure currently applied to the shutter button 6b is equivalent to the pressure applied to the shutter button 6b when it was brand new, the resulting stroke differs from the stroke provided when the shutter button 6b was brand new. For example, even if the same pressure is applied, the resulting stroke is shorter or longer than the stroke provided when the shutter button 6b was brand new.

Accordingly, based, for example, on the result of detection by the pressure sensor, a continuous operation time of the shutter button 6b, or an occurrence of error, the tactile sensation presentation control section 34 determines whether aging has occurred. For error determination, for example, a check is performed to determine whether the length of time between half depression and full depression is less than a predetermined length.

Subsequently, in a case where it is determined that aging has occurred, the tactile sensation presentation control section 34 generates a vibration waveform, for example, by increasing the strength of vibration, increasing the rate of vibration attenuation, or increasing the frequency of vibration. Further, when the shutter button 6b is operated, the tactile sensation presentation control section 34 exercises control to output a vibration based on the generated vibration waveform from the tactile sensation presentation device 22.

As described above, in a case where the shutter button 6b is found to be aged, the tactile sensation presentation control section 34 exercises control in such a manner that tactile sensation presentation is performed when an input signal corresponding to a depressing operation is acquired. This enables the tactile sensation presentation control section 34 to generate a vibration that imparts in a pseudo manner the feel of performing half-depressing and full-depressing operations equivalent to that imparted when the shutter button 6b was brand new.

### 5. Modifications

It should be noted that the embodiments are not limited to the foregoing embodiments. Various configurations may be adopted as a variety of modifications.

For example, the dial 6a and the shutter button 6b have been described as examples of adjustment objects. However, the adjustment objects are not limited to physical operating elements and, as long as the user can operate the adjustment objects, may be displayed items such as a bar displayed on the display section 15 or an object in a virtual space displayed, for example, on a head-mounted display.

Further, the imaging apparatus 1 has been described as an example of the information processing apparatus. However, various other apparatuses, such as a computer, a gaming device, and a television receiver, may alternatively be regarded as the information processing apparatus.

Further, the foregoing embodiments assume that the operating elements 6, the control section 17, and the tactile sensation presentation device 22 are disposed in the same camera housing 2. Alternatively, however, the operating elements 6, the control section 17, and the tactile sensation presentation device 22 may be separately disposed.

For example, the operating elements 6 and the tactile sensation presentation device 22 may be disposed, for example, on a remote controller, an external shutter button, a tripod, a handheld gimbal, a lens, and a camera accessory.

Moreover, the second embodiment provides vibration waveform generation and vibration waveform decimation. However, the tactile sensation presentation control section 34 may alternatively provide vibration waveform generation only or vibration waveform decimation only.

Additionally, in a situation where the dial 6a is continuously operated, the tactile sensation presentation control section 34 may preset a vibration waveform that is unlikely to connect one vibration to another. Here, the situation where the dial 6a is continuously operated is, for example, a case where the subject is small and rapidly zoomed in or a case where the Ev value or the shutter speed is rapidly increased due to a dark background. In such cases, the tactile sensation presentation control section 34 is able to reduce the possibility of connecting one vibration to another, by presetting a vibration waveform for a situation where an operation is performed for zooming or increasing the Ev value or the shutter speed.

### 6. Conclusions

The information processing apparatus (imaging apparatus 1) according to the above-described embodiments includes the input information acquisition section 33 and the tactile sensation presentation control section 34. The input information acquisition section 33 acquires the input information that is inputted when the user operates the adjustment objects (dial 6a and shutter button 6b). The tactile sensation presentation control section 34 exercises control to cause the tactile sensation presentation device 22 to provide tactile sensation presentation according to adjustment object usage based on the input information.

Consequently, the imaging apparatus 1 is able to cause the tactile sensation presentation device 22 to provide tactile sensation presentation (the vibration based on the vibration waveform) that varies with the adjustment object usage based on the input information.

As a result, the imaging apparatus 1 is able to improve usability by providing tactile sensation presentation according to the usage of the adjustment objects.

Further, it is conceivable that the tactile sensation presentation control section 34 learns the setting ranges of the parameters set through the adjustment objects, and cause tactile sensation presentation to be provided on the basis of the learning result.

Consequently, the imaging apparatus 1 is able to cause the tactile sensation presentation device 22 to provide tactile sensation presentation (the vibration based on the vibration waveform) without departing from a parameter setting range that is set on an individual user basis.

As a result, the imaging apparatus 1 is able to cause accurate tactile sensation presentation to be provided without departing from a required setting range, and thus further improve usability.

Further, it is conceivable that, in a case where the input information corresponding to both ends of the setting range is acquired, the tactile sensation presentation control section 34 causes tactile sensation presentation that represents the ends of the setting range to be provided.

Consequently, the imaging apparatus 1 is able to make it easy for the user to recognize the setting range.

As a result, the imaging apparatus 1 is able to reduce the possibility of the user making a parameter change beyond the setting range.

Moreover, it is conceivable that, in a case where the input information corresponding to a setting value within the setting range is acquired, the tactile sensation presentation control section 34 causes a tactile sensation that varies with the setting value to be presented.

Consequently, the imaging apparatus 1 is able to make it easy for the user to realize a periodic change within the setting range.

Additionally, it is conceivable that the tactile sensation presented by the tactile sensation presentation control section 34 in a case where the acquired input information corresponds to an integer value within the setting range is different from that in a case where the acquired input information corresponds to a non-integer value.

Consequently, the imaging apparatus 1 is able to make it easy for the user to realize an appropriate integer value.

Further, it is conceivable that, in a case where the acquired input information corresponds to the most frequently set value within the setting range, the tactile sensation presentation control section 34 presents a tactile sensation different from that in a case where the acquired input information corresponds to a certain other value.

Consequently, the imaging apparatus 1 is able to make it easy for the user to realize the most frequently set value.

Further, it is conceivable that, in a case where the presentation intervals (time interval t1) at which successive tactile sensations are presented are shorter than the perception limit time, the tactile sensation presentation control section 34 prevents one or more of the successive tactile sensations from being presented.

Consequently, the imaging apparatus 1 is able to reduce the possibility of multiple tactile sensation presentations being connected to one another and recognized as a single tactile sensation presentation.

As a result, the imaging apparatus 1 is able to reduce the possibility of erroneous recognition being caused by tactile sensation presentations.

Moreover, it is conceivable that, in a case where the presentation intervals (time interval t1) at which successive tactile sensations are presented are shorter than the perception limit time, the tactile sensation presentation control section changes one or more tactile sensation presentations to prevent the tactile sensation presentations from being shorter than the perception limit time.

Consequently, the imaging apparatus 1 is able to reduce the possibility of multiple tactile sensation presentations being connected to one another and recognized as a single tactile sensation presentation.

As a result, the imaging apparatus 1 is able to reduce the possibility of erroneous recognition being caused by tactile sensation presentations.

Additionally, it is conceivable that the adjustment objects are the operating elements 6, which are user-operable, and the tactile sensation presentation control section 34 exercises control to provide tactile sensation presentation according to an intensity of operation performed on the adjustment objects.

Consequently, the imaging apparatus 1 is able to provide constant tactile stimulation to the user irrespective of tactile sensitivity, which varies with the intensity of operation.

Further, it is conceivable that, in a case where the input information is acquired in an error situation related to an adjustment object operation, the tactile sensation presentation control section 34 exercises control to provide tactile sensation presentation.

Consequently, the imaging apparatus 1 is able to present a tactile sensation in such a manner as to provide assistance in avoiding errors as much as possible.

As a result, the imaging apparatus 1 is able to reduce the possibility of the user committing an error.

Further, it is conceivable that the tactile sensation presentation control section 34 causes tactile sensation presentation to be provided according to the environmental information obtained at the time of adjustment object operation.

Consequently, the imaging apparatus 1 is able to provide guidance for setting the parameters according to the usage environment.

Moreover, it is conceivable that the adjustment objects are the user-operable operating elements 6, and in a case where an adjustment object is found to be aged, the tactile sensation presentation control section 34 causes tactile sensation presentation to be provided in such a manner as to compensate for aging.

Consequently, the imaging apparatus 1 is able to reduce discomfort caused by the operation of an aged operating element 6.

Additionally, it is conceivable that, in a case where the speed of operation input at a predetermined position is increased due to adjustment object aging, the tactile sensation presentation control section 34 exercises control to provide tactile sensation presentation in such a manner as to compensate for aging upon acquisition of an input signal corresponding to an operation at the predetermined position.

Consequently, the imaging apparatus 1 is able to reduce discomfort caused by the operation of an aged operating element 6, even in a case where the vibration from the operating element is decreased due to an increased speed of operation input.

Further, it is conceivable that, in a case where the speed of operation input at a predetermined position is decreased due to adjustment object aging, the tactile sensation presentation control section 34 exercises control to provide tactile sensation presentation in such a manner as to compensate for aging upon acquisition of an input signal corresponding to an operation at a position other than the predetermined position.

Consequently, the imaging apparatus 1 is able to reduce discomfort caused by the operation of an aged operating element 6, even in a case where the vibration from the operating element is increased due to a decreased speed of operation input.

Further, it is conceivable that the adjustment objects are the user-operable operating elements 6, and in a case where an adjustment object is found to be aged, the tactile sensation presentation control section 34 causes tactile sensation presentation to be provided upon acquisition of an input signal corresponding to a predetermined operation.

Consequently, the imaging apparatus 1 allows the operating elements 6 to be operated in a feel similar to that of unaged operating elements 6.

An information processing method according to the above-described embodiments includes acquiring the input information that is inputted by a user operation performed on the adjustment objects, and exercising control in such a manner as to cause the tactile sensation presentation device to provide tactile sensation presentation according to the adjustment object usage based on the input information.

Additionally, a program according to the above-described embodiments causes a computer to perform a process of acquiring the input information that is inputted by a user operation performed on the adjustment objects, and exercising control in such a manner as to cause the tactile sensation presentation device to provide tactile sensation presentation according to the adjustment object usage based on the input information.

The above-described information processing method and program are also able to provide advantages similar to the advantages provided by the information processing apparatus.

It should be noted that the above-described program may be prerecorded, for example, on an HDD used as a recording medium built in a personal computer or other equipment or in a ROM or a flash memory in a microcomputer having a CPU.

Alternatively, the program may be temporarily or permanently stored (recorded) on a removable recording medium, such as a flexible disk, a CD-ROM (Compact Disc Read Only Memory), an MO (Magnet optical) disk, a DVD, a Blu-ray disk, a magnetic disk, a semiconductor memory, or a memory card. Such a removable recording medium can be supplied as what is generally called package software.

Further, the program may be not only installed, for example, on a personal computer from the removable recording medium, but also downloaded from a download website through a network such as a LAN (Local Area Network) or the Internet.

The advantages described in this document are merely illustrative and not restrictive. The present technology may additionally provide advantages other than those described in this document.

### 7. Present Technology

It should be noted that the present technology may additionally adopt the following configurations.

(1)

An information processing apparatus including:
an input information acquisition section that acquires input information inputted by a user operation performed on an adjustment object; and
a tactile sensation presentation control section that exercises control to cause a tactile sensation presentation device to provide tactile sensation presentation according to usage of the adjustment object that is based on the input information.
   (2)

The information processing apparatus according to (1),
in which the tactile sensation presentation control section learns a setting range of a setting item set through the adjustment object and exercises control to provide tactile sensation presentation on the basis of a learning result.
   (3)

The information processing apparatus according to (1) or (2),
in which, in a case where input information corresponding to both ends of the setting range is acquired, the tactile sensation presentation control section exercises control to provide tactile sensation presentation that represents the ends of the setting range.
   (4)

The information processing apparatus according to any of (1) to (3),
in which, in a case where input information corresponding to a setting value within the setting range is acquired, the tactile sensation presentation control section exercises control to present a tactile sensation that varies with the setting value.
   (5)

The information processing apparatus according to any of (1) to (4),
in which, in a case where the acquired input information corresponds to an integer, the tactile sensation presentation control section exercises control to present a tactile sensation different from that in a case where the acquired input information corresponds to a non-integer value.
   (6)

The information processing apparatus according to any of (2) to (5),
in which, in a case where the acquired input information corresponds to a most frequently set value within the setting range, the tactile sensation presentation control section exercises control to present a tactile sensation different from that in a case where the acquired input information corresponds to a certain other value.
   (7)

The information processing apparatus according to any of (1) to (6),
in which, in a case where presentation intervals at which successive tactile sensations are presented are shorter than a perception limit time, the tactile sensation presentation control section exercises control to prevent one or more of the successive tactile sensations from being presented.
   (8)

The information processing apparatus according to any of (1) to (7),
in which, in a case where presentation intervals at which successive tactile sensations are presented are shorter than a perception limit time, the tactile sensation presentation control section exercises control to change one or more tactile sensation presentations in such a manner as to prevent the tactile sensation presentations from being shorter than the perception limit time.
   (9)

The information processing apparatus according to any of (1) to (8),
in which the adjustment object includes a user-operable operating element, and
the tactile sensation presentation control section exercises control to provide tactile sensation presentation according to an intensity of an operation performed on the adjustment object.
   (10)

The information processing apparatus according to any of (1) to (9),
in which, in a case where the input information is acquired in an error situation related to an operation of the adjustment object, the tactile sensation presentation control section exercises control to provide tactile sensation presentation.
   (11)

The information processing apparatus according to any of (1) to (10),
in which the tactile sensation presentation control section exercises control to provide tactile sensation presentation according to environmental information obtained at the time of an operation of the adjustment object.
   (12)

The information processing apparatus according to any of (1) to (11),
in which the adjustment object includes a user-operable operating element, and
in a case where the adjustment object is found to be aged, the tactile sensation presentation control section exercises control to provide tactile sensation presentation in such a manner as to compensate for aging.
   (13)

The information processing apparatus according to (12), in which, in a case where a speed of an operation input at a predetermined position is increased due to the aging of the adjustment object, the tactile sensation presentation control section exercises control to provide tactile sensation presentation in such a manner as to compensate for aging upon acquisition of an input signal corresponding to an operation at the predetermined position.

(14)

The information processing apparatus according to (12) or (13),
in which, in a case where a speed of an operation input at a predetermined position is decreased due to the aging of the adjustment object, the tactile sensation presentation control section exercises control to provide tactile sensation presentation in such a manner as to compensate for aging upon acquisition of an input signal corresponding to an operation at a position other than the predetermined position.
   (15)

The information processing apparatus according to any of (1) to (14),
in which the adjustment object includes a user-operable operating element, and
in a case where the adjustment object is found to be aged, the tactile sensation presentation control section exercises control to provide tactile sensation presentation upon acquisition of an input signal corresponding to a predetermined operation.
   (16)

An information processing method including:
acquiring input information inputted by a user operation performed on an adjustment object; and
exercising control to cause a tactile sensation presentation device to provide tactile sensation presentation according to usage of the adjustment object that is based on the input information.
   (17)

A program for causing a computer to perform a process of:
acquiring input information inputted by a user operation performed on an adjustment object; and
exercising control to cause a tactile sensation presentation device to provide tactile sensation presentation according to usage of the adjustment object that is based on the input information.

### REFERENCE SIGNS LIST

1: Imaging apparatus
6: Operating element
17: Control section
22: Tactile sensation presentation device
33: Input information acquisition section
34: Tactile sensation presentation control section

1. An information processing apparatus comprising:
an input information acquisition section that acquires input information inputted by a user operation performed on an adjustment object; and
a tactile sensation presentation control section that exercises control to cause a tactile sensation presentation device to provide tactile sensation presentation according to usage of the adjustment object that is based on the input information.

2. The information processing apparatus according to claim 1,
wherein the tactile sensation presentation control section learns a setting range of a parameter set through the adjustment object and exercises control to provide tactile sensation presentation on a basis of a learning result.

3. The information processing apparatus according to claim 2,
wherein, in a case where input information corresponding to both ends of the setting range is acquired, the tactile sensation presentation control section exercises control to provide tactile sensation presentation that represents the ends of the setting range.

4. The information processing apparatus according to claim 2,
wherein, in a case where input information corresponding to a setting value within the setting range is acquired, the tactile sensation presentation control section exercises control to present a tactile sensation that varies with the setting value.

5. The information processing apparatus according to claim 4,
wherein, in a case where the acquired input information corresponds to an integer, the tactile sensation presentation control section exercises control to present a tactile sensation different from that in a case where the acquired input information corresponds to a non-integer value.

6. The information processing apparatus according to claim 2,
wherein, in a case where the acquired input information corresponds to a most frequently set value within the setting range, the tactile sensation presentation control section exercises control to present a tactile sensation different from that in a case where the acquired input information corresponds to a certain other value.

7. The information processing apparatus according to claim 1,
wherein, in a case where presentation intervals at which successive tactile sensations are presented are shorter than a perception limit time, the tactile sensation presentation control section exercises control to prevent one or more of the successive tactile sensations from being presented.

8. The information processing apparatus according to claim 1,
wherein, in a case where presentation intervals at which successive tactile sensations are presented are shorter than a perception limit time, the tactile sensation presentation control section exercises control to change one or more tactile sensation presentations in such a manner as to prevent the tactile sensation presentations from being shorter than the perception limit time.

9. The information processing apparatus according to claim
wherein the adjustment object includes a user-operable operating element, and
the tactile sensation presentation control section exercises control to provide tactile sensation presentation according to an intensity of an operation performed on the adjustment object.

10. The information processing apparatus according to claim 1,
wherein, in a case where the input information is acquired in an error situation related to an operation of the adjustment object, the tactile sensation presentation control section exercises control to provide tactile sensation presentation.

11. The information processing apparatus according to claim 1,
wherein the tactile sensation presentation control section exercises control to provide tactile sensation presentation according to environmental information obtained at a time of an operation of the adjustment object.

12. The information processing apparatus according to claim
wherein the adjustment object includes a user-operable operating element, and
in a case where the adjustment object is found to be aged, the tactile sensation presentation control section exercises control to provide tactile sensation presentation in such a manner as to compensate for aging.

13. The information processing apparatus according to claim 12,
wherein, in a case where a speed of an operation input at a predetermined position is increased due to the aging of the adjustment object, the tactile sensation presentation control section exercises control to provide tactile sensation presentation in such a manner as to compensate for aging upon acquisition of an input signal corresponding to an operation at the predetermined position.

14. The information processing apparatus according to claim 12,
wherein, in a case where a speed of an operation input at a predetermined position is decreased due to the aging of the adjustment object, the tactile sensation presentation control section exercises control to provide tactile sensation presentation in such a manner as to compensate for aging upon acquisition of an input signal corresponding to an operation at a position other than the predetermined position.

15. The information processing apparatus according to claim 1,
wherein the adjustment object includes a user-operable operating element, and
in a case where the adjustment object is found to be aged, the tactile sensation presentation control section exercises control to provide tactile sensation presentation upon acquisition of an input signal corresponding to a predetermined operation.

16. An information processing method comprising:
acquiring input information inputted by a user operation performed on an adjustment object; and
exercising control to cause a tactile sensation presentation device to provide tactile sensation presentation according to usage of the adjustment object that is based on the input information.

17. A program for causing a computer to perform a process of:
acquiring input information inputted by a user operation performed on an adjustment object; and
exercising control to cause a tactile sensation presentation device to provide tactile sensation presentation according to usage of the adjustment object that is based on the input information.
